(19) United States
(12) Patent Application Publication
(10) Pub. No.: US 2025/0225231 A1
(43) Pub. Date: Jul. 10, 2025

(54) APPARATUS AND METHOD FOR INTENT-DRIVEN SECURE EXECUTION OF WORKFLOWS AND A NON-TRANSITORY COMPUTER-READABLE MEDIUM

(71) Applicants: Piotr ZMIJEWSKI, Gdansk PM (PL); Mateusz BRONK, Gdansk (PL); Arkadiusz BERENT, Tuchom (PL); Krystian MATUSIEWICZ, Gdansk PM (PL)

(72) Inventors: Piotr ZMIJEWSKI, Gdansk PM (PL); Mateusz BRONK, Gdansk (PL); Arkadiusz BERENT, Tuchom (PL); Krystian MATUSIEWICZ, Gdansk PM (PL)

(21) Appl. No.: 19/091,898

(22) Filed: Mar. 27, 2025

(51) Int. Cl. G06F 21/52

(52) U.S. Cl. CPC G06F 21/52; G06F 2221/033

(57) ABSTRACT

It is provided a non-transitory computer-readable medium storing instructions that, when executed by one or more processing circuitries, causing the one or more processing circuitries to perform a method. The method comprises receiving a user-defined intent specifying a high-level computational goal. The method further comprises generating an execution workflow of the computational goal based on the one or more computational components corresponding to the user-defined intent. The method further comprises executing the execution workflow according to obtained execution constraints. The execution workflow is executed within an isolated execution environment, the isolated execution environment being deployed inside a trusted execution environment. The method further comprises monitoring the execution of the execution workflow within the isolated execution environment ensuring compliance with the execution constraints.

### BACKGROUND

Intention-driven computing (also referred to as intent-based programming) may represent a shift from traditional instruction-based computing, in which a system is explicitly told what to do, towards more flexible and context-aware systems capable of understanding and responding to a user's intent. This shift, enabled for example by advances in artificial intelligence, machine learning, and natural language processing, allows systems to interpret what a user aims to achieve, rather than merely executing predefined commands. Combined with broader concepts of machine programming—where systems may generate their own software dynamically—this leads to scenarios in which users may no longer have full control or visibility over what is executed. Once a user specifies a high-level intent, the system automatically interprets the intent and dynamically assembles and executes software or services to fulfill the specified computational goal. However, this dynamic and autonomous assembly of software components and services may introduce a trust gap. When a system fulfills a task using dynamically selected and assembled computational components, even if the individual components themselves are trustworthy, there remains uncertainty regarding the correctness, security, and reliability of the assembled solution as a whole. Assurance may be required not only for the individual components but also for their orchestration and interactions. This challenge may further be complicated by the uniqueness of each execution instance, making comparison to known-good references impractical. From the service provider's perspective, there is a desire to retain the flexibility to dynamically exchange components, for example, to optimize costs or meet service level agreements, without the need for renegotiation or manual intervention.

### BRIEF DESCRIPTION OF THE FIGURES

Some examples of apparatuses and/or methods will be described in the following by way of example only, and with reference to the accompanying figures, in which

FIG. 1 illustrates a block diagram of an example of a non-transitory computer-readable medium;

FIG. 2 illustrates a block diagram of an example of an apparatus or device;

FIG. 3 illustrates a flowchart of an example of a method;

FIG. 4 illustrates an example of a setup stage of a programming flow for user-defined intent programming; and

FIG. 5 illustrates an example of a runtime stage of a programming flow for user-defined intent programming.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

As described above Intent-based programming represents a shift from traditional, instruction-based computing (see also “Intention-Driven Computing: Reality or Sci-Fi?”, available at: https://www.linkedin.com/pulse/intention-driven-computing-reality-sci-fi-afshin-asli-0e4vc). Existing approaches in this regard, such as machine programming systems (see for example Gottschlich, Justin, et al. “The three pillars of machine programming.” Proceedings of the 2nd ACM SIGPLAN International Workshop on Machine Learning and Programming Languages. 2018), may rely on a high degree of trust from users with respect to the system that translates a user-defined intent into an execution workflow of computational components, the computational components themselves, and the execution environment. In some cases, where the system, execution environment, or computational components are open source, a user may inspect the source code to a limited extent. However, due to the complex and dynamic nature of such systems, in which computational components may be dynamically exchanged during execution, achieving a meaningful level of assurance regarding the correctness and security of the overall execution may be impractical or infeasible. Existing solutions providing a high level of trust, such as those based on confidential computing technologies (see Wikipedia: “Confidential computing”), may rely on a static composition of the service and fixed integrity measurements. In such systems, any ad hoc modification of the service during execution generally requires prior agreement and contract renegotiation with the relying party, which limits flexibility and dynamic adaptation during runtime.

The herein described technique may introduce a new form of sandbox component, appraising the correctness of an ad-hoc software or service package (dynamically assembled based on user-defined intent) and its execution. The proposed technique may address the problem of trust in cases where software components (be it libraries or web services) are dynamically assembled (often by a 3rd party system and beyond user direct control) to realize complex tasks. The significance of this problem grows, as new programming paradigms emerge, such as intent-driven programming. In such a paradigm, the user specifies task to be executed in the form of a high-level intent that is then processed by a system that analyzes the intent and translates it to an execution plan (a form of executable workflow). The workflow may implement business logic required to realize the task, including interactions with a given set of components or classes of components. The execution workflow may be run in a target execution environment that provides access to all the ingredients required to complete the plan.

The proposed technique may introduce a mechanism that allows to formally assess the correctness of a dynamically assembled software or service package and its execution. The appraising mechanism may analyze inputs/outputs as well as resource usage for abnormalities (e.g. SLA adherence, resource starvation, possible attempts made at data exfiltration, compliance etc.). In case the mechanism detects abnormalities (e.g. SLA breach), it may take further actions, like banning the offending software/service from executing, or take remediations, like dynamically exchanging the faulty software/services for alternative versions. The mechanism, having direct access to the user data and requirements, can fully monitor execution of third-party software/service and create an execution certificate (for offline analysis). The proposed technique may take a form of a trusted execution container with a set of governor components that may have direct access to the user data and requirements, fully monitor execution of third-party software/service and create an execution certificate (that can be examined later on, and used for billing, for example).

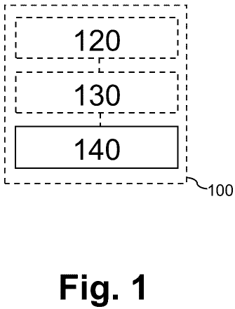

FIG. 1 illustrates a block diagram of an example of a non-transitory computer-readable medium 140. The non-transitory computer-readable medium 140 stores instructions that, when executed by one or more processing circuitries 130, causes the one or more processing circuitries 130 to perform a method (for example the method 300). The one or more processing circuitries 130 may access the non-transitory computer-readable medium 140 via an interface circuitry 120. In some examples, the non-transitory computer-readable medium 140 may be included in an apparatus 100, which may also comprise the one or more processing circuitries 130. In some examples, the one or more processing circuitries 130 may be distributed over a plurality of apparatuses and may for example, access the non-transitory computer-readable medium 140 via the interface circuitry 120.

For example, the non-transitory computer-readable medium may refer to any tangible, physical medium capable of storing instructions, data, or other types of information for access by a computer, processor, or similar electronic device. The computer-readable medium may be non-transitory in that medium may have a persistent or enduring form. The non-transitory computer-readable medium may comprise one or more of the following computer-readable mediums: magnetic storage devices, such as hard disk drives (HDDs) and magnetic tapes, which store data using magnetic patterns and are commonly used for long-term data storage in computers, servers, and backup systems. Optical storage media, including compact discs (CDs), digital versatile discs (DVDs), and Blu-ray discs, utilize laser technology to read and write data, offering durability and longevity for storing software, media, and backups. More modern forms include solid-state devices (SSD), which rely on flash memory technology without moving parts, such as USB flash drives, secure digital (SD) cards, and internal/external SSDs, valued for their fast read/write speeds and portability. Additionally, non-volatile memory chips like read-only memory (ROM) and programmable ROM (PROM) store critical firmware or embedded software, commonly found in embedded systems and computers. Advanced memory technologies, such as phase-change memory (PCM), magnetoresistive RAM (MRAM), and ferroelectric RAM (FeRAM), offer persistent data storage with high reliability, speed, and power efficiency, making them ideal for applications requiring rapid access and data retention, such as in mobile devices, high-performance computing, and industrial systems.

For example, the one or more processing circuitries 130 may access the non-transitory computer-readable medium 140 over the interface circuitry 120. For example, the one or more processing circuitries 130 may then execute the instructions stored on the non-transitory computer-readable medium 140. The execution of the instructions stored on the non-transitory computer-readable medium 140 causes the one or more processing circuitries 130 to perform the method (for example the method 300. The method comprises receiving a user-defined intent specifying a high-level computational goal. For example, the one or more processing circuitries 130 may receive the user-defined intent through the interface circuitry 120, where the user-defined intent may originate from various sources such as storage circuitry 140 or an external source. The storage circuitry 140 may store the user-defined intent locally, such as in a database, memory module, or other persistent storage mediums, while the external source may include remote servers, user devices, or networked systems transmitting the user-defined intent over wired or wireless communication channels. The user-defined intent may be received from a user through various input methods, such as manual text input via a graphical user interface, voice input processed through speech recognition systems, or other forms of human-machine interaction that allow the user to express the high-level computational goal. The interface circuitry 120 may facilitate the transfer of the user-defined intent data, regardless of the input method, into the processing circuitries 130 for further handling and interpretation.

For example, the user-defined intent may be information that specifies a high-level computational goal describing an abstract objective that is to be accomplished by a computational system, such as apparatus 100, without detailing specific implementation steps. The high-level computational goal may define the desired result of the computation, such as producing an output dataset, performing an analysis, or executing a sequence of operations on input data, while leaving the choice of computational components, execution sequence, and infrastructure to the computational system. In some examples, the user-defined intent may be expressed in machine-readable data formats that enable automatic processing by the one or more processing circuitries 130, such as JSON, XML, or YAML documents, domain-specific languages, or intent-driven programming models. The user-defined intent may also be provided using frameworks such as FAST, as described in paper Yang, Yao-Hsiang, et al. “Language Support for Adaptation: Intent-Driven Programming in FAST.” arXiv preprint arXiv: 1907.08695 (2019). In this paper it is described how to supply syntax and structures to formalize the high-level computational goal together with related adaptation objectives, such as minimizing latency or optimizing resource usage during execution. The user-defined intent may additionally specify execution constraints, optimization preferences, or security policies, which the system incorporates when generating and executing the workflow.

In some examples, the received user-defined intent comprises one or more actions of the computational goal. For example, the actions of the high-level computational goal comprised in the received user-defined intent may be discrete functional elements, each corresponding to a concrete step that must be executed to complete the overall computational goal. The actions may be provided directly within the user-defined intent as part of a structured data representation, such as a JSON array listing the required operations in sequence, or they may be embedded within natural language input and extracted through intent parsing techniques. Each action may include associated metadata, such as required input and output formats, dependencies on other actions, and applicable execution constraints, allowing the system to correctly interpret the actions and assemble them into an executable workflow that performs the full computation as intended by the user. For example, the user-defined intent specifying the computational goal is “book a flight from Munich to Warsaw” and actions are “retrieve available flight data,” “filter results by price,” “process payment,” or “generate confirmation”.

For example, the user-defined intent may comprise high-level computational goals such as “summarize customer feedback,” “detect anomalies in network traffic,” or “convert video streams into optimized formats,” which the system can interpret and translate into executable workflows. In other examples, the user-defined intent may comprise a high-level computational goal “book a flight from Munich to Warsaw,” where the computational system identifies and composes computational components for querying flight databases, filtering available options, handling payment processing, and generating booking confirmations. In another example, the user-defined intent may comprise the high-level computational goal “generate a financial report from quarterly transaction data,” where the system selects appropriate components for data aggregation, statistical analysis, and report generation, while complying with specified constraints on processing time and data confidentiality.

The method performed by the one or more processing circuitries 130, when executing the introductions stored on the non-transitory computer-readable medium further comprises generating an execution workflow of the computational goal based on one or more computational components corresponding to the user-defined intent. A computational component may be a discrete computational unit designed to perform a specific computational task or process. The computational component may expose standardized inputs and outputs, allowing it to receive data, apply its internal logic or algorithm, and produce results. Computational components may be designed to be composable, meaning they can be connected with other components through compatible interfaces to form larger, more complex processes. Computational components may interact with each other within the execution workflow arranged in a defined order according to the user-defined intent, which articulates the overall computational goal.

In some examples, the computational components may comprise at least one of a service class, a script, dynamically compiled code, or an execution module. For example, a service class may be a category of services that provide a specific type of functionality required to perform an action of the high-level computational goal. A service class may describe the general capabilities of services, including the type of operation performed, expected input and output formats, and relevant performance or security attributes, without specifying a concrete implementation or instance of the service. For example, a service class may be a PDF reader module that extracts text and metadata from PDF documents, converts them into structured formats, and provides interfaces for further processing in a larger workflow, such as document classification or search indexing. For each service class, there may be one or more service instances available in the target environment, where each service instance provides a concrete implementation of the service class, enabling the system to select a specific service instance during workflow execution based on factors such as availability, performance, or compliance with execution constraints.

A script may be a sequence of instructions written in a high-level scripting language designed to execute a defined set of operations or automate specific tasks within a workflow. Scripts may be used to prepare data, trigger processes, or orchestrate interactions between components. For instance, a script may be a data cleaning routine written in Python that loads raw CSV files, removes duplicate entries, applies transformations to standardize values, and then calls a machine learning training component to process the cleaned data.

Dynamically compiled code may be source code that is generated and compiled during runtime, allowing for the creation of task-specific executable logic based on user input or real-time conditions. An example may be just-in-time generated GPU kernels, where code is created on demand to process large image datasets, dynamically optimized for the current hardware configuration and data size before immediate execution.

An execution module may be a deployable computational unit designed to perform a specific task within a workflow and expose standardized input and output interfaces. This may include precompiled binaries, containerized services, or callable function packages. For example, an execution module may be a video transcoding service packaged in a Docker container, which accepts video files, converts them into different formats, and provides the output for further streaming or storage, callable through an API within a larger media processing pipeline.

The execution workflow may be a structured sequence of interconnected computational components that are arranged to collectively perform the computational goal according to the user-defined intent. Within the execution workflow, each computational component may carry out a specific task, and the output of one computational component may become the input for another, ensuring a continuous and coordinated data flow from the initial input to the final result. The execution workflow may define the logical order of execution, data dependencies, resource allocations, and error handling procedures. They may support various data formats at each stage, such as JSON for structured data exchange, CSV for tabular datasets, binary formats for media content, or domain-specific formats like PDF, XML, or image files, depending on the nature of the computational goal and the requirements of the involved components.

For example, the generation of the execution workflow comprises parsing the received intent to extract one or more actions of the computational goal. For example, the parsing may comprise analyzing the structured or unstructured content of the user-defined intent to identify discrete computational steps required to fulfill the specified computational goal. The parsing may comprise interpreting machine-readable formats, such as JSON, XML, or YAML, or processing natural language input to determine relevant parameters, objectives, and constraints expressed within the user-defined intent. Based on this analysis, the system may decompose the high-level computational goal into individual actions, such as data retrieval, data processing, filtering, validation, or output generation, each representing a specific operation to be carried out by corresponding computational components during execution.

Further, these extracted actions may then serve as the foundation for selecting appropriate computational components and constructing the executable workflow needed to achieve the computational goal defined by the user. That is each action may correspond to a specific function necessary for achieving the computational goal. For example, appropriate computational components may be selected, wherein each computational component may be chosen because its input and output data formats, algorithmic efficiency, and resource requirements match the needs of the corresponding action. The selected computational components may be organized in a logical sequence such that the output of one computational component becomes the valid input for the next computational component. Dependencies, execution logic, and resource allocation between the computational components may be automatically managed during this process, resulting in a seamless data flow that fulfills the computational goal without requiring manual integration.

For example, the computational component is a service class. For example, the method further comprises querying a service registry to identify one or more service classes matching the extracted actions of the computational goal. The service registry may be implemented as a structured database or directory that stores detailed descriptions of available service classes, including the functionalities they provide, supported input and output formats, performance characteristics, and applicable constraints. In some examples, the querying may involve searching the service registry for service classes whose declared capabilities correspond to the extracted actions, thereby enabling the system to select appropriate service classes for each step of the execution workflow. For instance, if an extracted action specifies “process payment,” the service registry may return a list of payment processing service classes that support secure transactions and satisfy any defined policy requirements.

For example, in the paper Khalfallah, Malik, et al. “Generating Executable Workflows from Solution Plans.” 2015 IEEE International Conference on Web Services. IEEE, 2015 an implementation of an execution workflow generation is described. In this paper a framework is described for dynamically orchestrating containerized services in distributed computing environments. The computational components are provided as containerized microservices that expose standard interfaces. The user-defined intent is provided through semantic analysis or predefined templates and then the containerized computational components are selected that match the user-defined intent. Then subsequently an execution workflow is generated by linking the computational components, ensuring that data formats are converted as necessary and that the order of execution and resource allocations are properly managed.

For example, the user-defined intent may specify the high-level computational goal of “book a flight from Munich to Warsaw”. The use-defined intent may be received in the form of a structured JSON document comprising fields such as “departure_city”: “Munich,” “destination_city”: “Warsaw,” “departure_date”: “2025 Jun. 15,” “return_date”: “2025 Jun. 20,” “max_price”: “200 EUR”. The generation of the execution workflow may comprise an analysis of the user-defined intent, wherein the structured data of the JSON document is parsed to extract the relevant parameters of the high-level computational goal. The analysis may map the high-level computational goal to a defined series of actions required to complete the booking, such as querying available flights, applying filtering criteria based on price and airline preferences, processing payment, and generating a confirmation receipt. For example, the execution workflow may include computational components specifically selected to perform the respective actions, wherein a flight search component receives the parsed travel parameters as input in JSON format and outputs a list of flight options in XML format. A filtering component may receive the XML list of flights as input, apply sorting and filtering algorithms according to the user's maximum price and airline preferences, and output a refined list of flight options in CSV format. A payment processing component may accept the selected flight details as input in CSV format, perform secure payment authorization, and generate a payment confirmation in PDF format. Finally, a booking confirmation component may compile the finalized flight details and payment confirmation into a single PDF document, which is delivered to the user. Throughout the execution workflow, dependencies between the computational components may be automatically managed, ensuring that the output format of each computational component is compatible with the input format of the subsequent computational component.

In some examples, generating the execution workflow of the computational goal may be further based on obtained execution constraints. For example, execution constraints may be parameters, conditions, or policies that define the operational boundaries within which the execution workflow is to be performed, ensuring that the execution of the computational goal adheres to specific quality, performance, and/or security requirements as specified by the user-defined intent or the system configuration. Execution constraints may comprise, for instance, Quality of Service (QOS) objectives such as maximum latency, minimum throughput, or resource consumption limits. Execution constraints may be applied throughout the execution of the workflow to control and monitor the behavior of the computational components, ensuring that the computational components remain compliant with these constraints, and may be enforced either by the isolated execution environment itself or by dedicated monitoring components operating within the trusted execution environment.

In some examples, generating the execution workflow of the computational goal may be further based on obtained execution constraints. For example, the execution constrains may may define the specific operational, performance, and security boundaries within which the workflow must execute to satisfy the user-defined intent and the system's policies. Execution constraints may include, for instance, Quality of Service (QOS) parameters or Service Level Agreement (SLA) conditions that specify mandatory thresholds such as maximum permitted latency, minimum throughput, resource consumption limits (like CPU, memory, or network usage), data privacy requirements, or other execution guarantees. These execution constraints may be integrated into the execution workflow in multiple ways: they may be statically embedded into the execution workflow during its generation based on the user-defined intent, ensuring that the selected computational components and the overall workflow structure align with the specified constraints; or they may be dynamically applied at runtime alongside the input data, adapting the execution behavior according to real-time conditions within the target environment.

For example, in the context of a travel booking execution workflow designed to handle reservations, the execution constraints may vary depending on seasonal demand. During a high-traffic period such as Christmas, the execution constraints may specify that at least 100 trip bookings per second must be handled by the services invoked within the workflow to maintain the required service levels. By contrast, during off-peak periods, the execution constraints may lower this requirement to 10 bookings per second, reflecting reduced demand. These constraints may be enforced throughout the execution of the workflow, with monitoring components ensuring that the computational components are meeting the defined performance levels, and triggering corrective actions if violations are detected (see below).

For example, when generating the execution workflow, beside the extracted actions of the high-level computational goal also the specific execution constraints that define how the workflow must perform may be considered. The execution constraints may influence the selection, arrangement, and configuration of the computational components that are assembled into the execution workflow, ensuring that the overall workflow is optimized to meet requirements such as maximum permitted latency, resource usage limits, security policies, or availability guarantees. For instance, if an execution constraint specifies that the workflow must complete within a certain response time, the system may prioritize the selection of computational components that are known to execute efficiently and reduce processing overhead, or it may structure the workflow to enable parallel execution of certain actions to meet timing requirements. In this way, the execution workflow is not merely a sequence of actions fulfilling the computational goal but is also shaped by the execution constraints to ensure compliant, reliable, and optimized operation during runtime.

The method performed by the one or more processing circuitries 130, when executing the introductions stored on the non-transitory computer-readable medium further comprises executing the execution workflow according to obtained execution constraints. For example, the execution workflow is executed in a manner that satisfies the technical, operational, and/or policy-related limitations specified by the execution constraints. The execution constraints may define requirements such as maximum permitted processing time, limitations on resource consumption (including CPU, memory, and network bandwidth), or specific security and compliance rules, such as restricting the use of only authorized computational components or ensuring that data is processed within protected environments. The execution workflow may be generated and structured in such a way that some or all of the execution constraints may be inherently considered during execution, for instance, by selecting computational components with nominal compatible performance characteristics, arranging the sequence of actions to optimize processing time, or ensuring that sensitive operations are handled by components that comply with the required security standards. Further, the compliance of the execution constraints may be monitored during execution (see below).

The execution workflow is executed within an isolated execution environment. The isolated execution environment is deployed inside a trusted execution environment (TEE). For example, the isolated execution environment may be a logically and/or operationally separated computing environment with the computing system that provides controlled execution of code and processing of data while restricting interaction with other processes, workloads, or users operating within the same target environment. An isolated execution environment may ensure that the resources, memory spaces, and execution contexts of the workflow are kept separate from external systems, protecting the execution from unauthorized access, unintended interference, or data leakage. The isolated execution environment may provide a defined boundary within which computational components of the execution workflow are executed according to specified operational and security requirements, without exposure to the rest of the computation system. In some examples, the isolated execution environment may be at least one of a virtual machine (VM), a container or a software application. The VM may be a virtualized instance of a complete operating system running on top of a hypervisor that emulates hardware resources, allowing the workflow to operate as though it were on a dedicated physical machine while remaining logically separated from other virtual machines and the host system. The container may be a lightweight virtualization mechanism that packages the execution workflow together with its necessary libraries, dependencies, and runtime environment, executing the execution workflow as an isolated process on a shared operating system kernel while preventing access to other containers and processes. The software application may be specifically designed to encapsulate and execute the execution workflow within a restricted and controlled user-space environment, applying internal sandboxing, resource controls, or policy enforcement to prevent interactions with external systems beyond defined communication interfaces.

For example, the TEE may be a secure, hardware-supported computing environment that provides protection for code and data during execution, ensuring that they remain confidential and protected from unauthorized access or tampering, even from privileged software such as operating systems, hypervisors, or administrators. The trusted execution environment may establish a secure boundary within the target environment, using hardware-based mechanisms to encrypt memory, verify the integrity of loaded code, and restrict access to internal states, allowing sensitive workflows to be executed securely on otherwise untrusted infrastructure. In some examples, the trusted execution environment may be at least one of an Intel® software guard extensions (SGX) or an Intel® trust domain extensions (TDX).

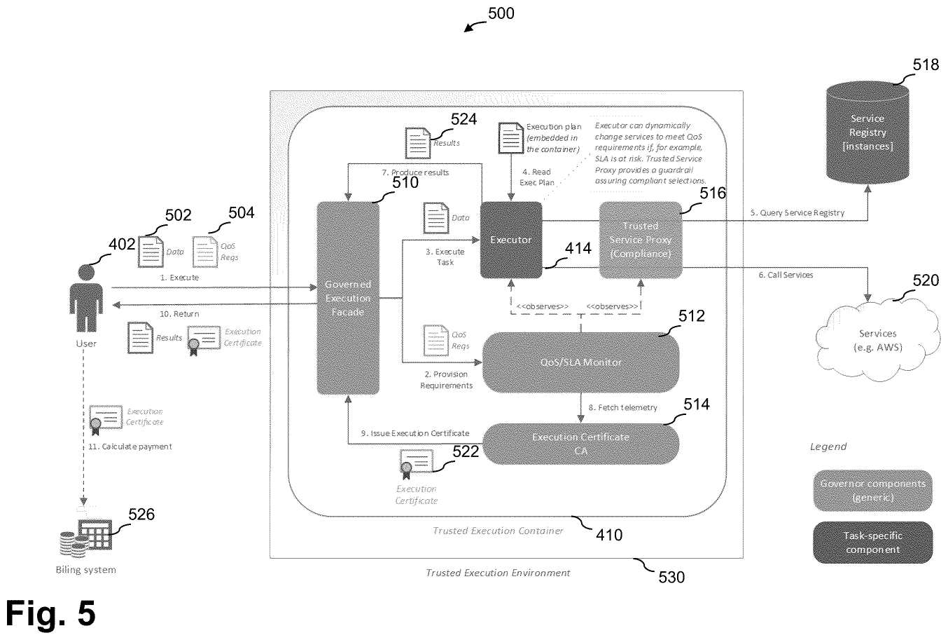

In this context, the isolated execution environment may be executed within the trusted execution environment, meaning that the complete runtime of the isolated execution environment operates entirely inside the secure boundary of the trusted execution environment. This may include the computational components of the workflow, their dependencies, and any dynamically loaded code. For example, this may include the components of the Governor, as illustrated in FIG. 5, a governed execution façade, a quality of service monitor, an execution certificate authority and/or a trusted service proxy (see FIG. 5). By executing the isolated execution environment within the trusted execution environment, the system ensures that the entire workflow, along with all intermediate data and execution states, benefits from the hardware-backed confidentiality and integrity protections of the trusted execution environment while still maintaining the operational advantages of a modular, manageable execution structure provided by the isolated execution environment, such as a virtual machine or container. In other words, by executing the isolated execution environment within the trusted execution environment it can be formally proven that a given workflow was executed in a “governed” fashion in a TEE by means of remote attestation.

In some examples, the TEE may be deployed in a target environment (TE, also referred to as computational system). For example, the apparatus 100 may be a TE. For example, the TE may be the overall computational system that provides the physical and virtual resources necessary to support the execution of workflows, including hosting the trusted execution environment and making available the infrastructure required for secure and reliable processing. The TE may include hardware resources, networking capabilities, storage systems, and runtime platforms that enable the deployment and operation of the trusted execution environment and the isolated execution environment contained within it. For example, the TE may be a cloud environment, such as a public or private cloud providing scalable compute resources; an on-premises server infrastructure, where dedicated servers within a controlled facility manage secure workload execution; or an edge computing environment, where distributed and often resource-constrained devices process data closer to its source while still supporting secure execution capabilities.

In some examples, the TE may provide one or more instances of the one or more computational components that may be required for the execution workflow. Computational components may be made available within the TE in the form of deployable services, applications, or code modules that the system can select, configure, and execute as part of fulfilling the high-level computational goal defined by the user. The availability of computational components within the target environment may depend on the specific capabilities and resources of the environment, such as which services are pre-installed, which APIs are exposed, and which external systems are accessible, all of which influence how the workflow is composed and executed.

For example, the TE may be the broader computational system that provides the underlying infrastructure, such as servers, networks, storage, and runtime platforms, where secure execution is required. Within the TE, the TEE may establish a hardware-backed secure zone that protects code and data from unauthorized access or tampering, even in cases where the TE itself may not be fully trusted. The TEE may create a protected boundary within the TE, ensuring that sensitive computations are executed securely, with guarantees of confidentiality and integrity. To carry out complex workflows within this protected boundary, the isolated execution environment, such as a virtual machine, container, or secure application, may be deployed inside the TEE to provide a structured and controlled space for executing the workflow's computational components. This structure may allow for a clear separation of responsibilities and layered protection: the TE may provide the general computing resources and connectivity; the TEE may add a secure foundation that protects against low-level attacks and ensures the trustworthiness of the execution; and the isolated execution environment may manage the actual execution of the execution workflow, allowing for modularity, flexibility, and dynamic component handling. By running the isolated execution environment inside the TEE, the system combines the security guarantees of hardware-backed isolation with the operational benefits of a flexible, maintainable, and scalable execution runtime. This layered design supports dynamic, secure, and policy-compliant execution of workflows, even in environments where parts of the infrastructure or external services may not be fully trusted.

The method performed by the one more processing circuitries 130, when executing the introductions stored on the non-transitory computer-readable medium further comprises monitoring the execution of the execution workflow within the isolated execution environment ensuring compliance with the execution constraints. For example, monitoring the execution of the execution workflow within the isolated execution environment comprises continuously observing, tracking, or inspecting the behavior of the execution workflow while it is running. It may further comprise collecting information about the state and performance of the computational components, the data flows between them, and the overall progress of the execution workflow. Monitoring may comprise measuring key operational metrics, such as processing times, resource usage (including CPU, memory, and network consumption), service response times, or the successful completion of individual actions. The monitoring may comprise detecting anomalies, failures, or unexpected behavior during execution.

Further, compliance with the execution constraints may be ensured by evaluating whether the actual execution of the workflow adheres to the specific conditions and limitations defined by the execution constraints. For example, maintaining required performance levels, respecting resource limits, or using only authorized computational components. If the monitoring detects that an execution constraint is at risk of being violated or has already been violated a corrective action may be triggered. For example, if a computational component is exceeding its maximum allowed response time or an unauthorized service is called. A corrective action may comprise terminating or restarting parts of the workflow, replacing computational components with alternative instances, reallocating resources, or even halting the entire execution if compliance cannot be restored. In this way, monitoring within the isolated execution environment enables active enforcement of the execution constraints and helps maintain the integrity, reliability, and security of the workflow

In some examples, the one more processing circuitries 130, when executing the introductions stored on the non-transitory computer-readable medium may further comprise modifying the execution of the execution workflow upon detecting a violation of an execution constraint, in accordance with an execution policy. For example, the execution policy may define predefined rules, conditions, and actions that determine how the system responds when a violation of an execution constraint is detected during the execution of the workflow. The execution policy may specify acceptable operational boundaries, such as maximum resource usage, permitted service instances, or time limits for specific actions, and may prescribe how the system should handle violations of these constraints to maintain the security, reliability, and correctness of the workflow. The execution policy may also define escalation procedures, fallback strategies, or service replacement criteria, ensuring that corrective actions are automatically applied within the TEE without requiring external intervention. In some cases, the execution policy may be directly derived from the user-defined intent, organizational guidelines, or regulatory compliance requirements, ensuring that the workflow continues to operate within acceptable parameters.

For example, modifying the execution of the execution workflow upon detecting a violation of an execution constraint may involve dynamically replacing an underperforming service instance with an alternative that better satisfies the defined execution constraints, restarting failed components, reallocating additional computational resources to critical actions, or skipping non-essential steps to meet timing deadlines. For instance, if an execution constraint specifies that a flight search operation must complete within two seconds, and the currently selected service instance exceeds this threshold, the system may switch to a faster alternative service instance or reduce the search scope to fewer providers. Similarly, if a payment processing component fails to comply with required security constraints, the system may automatically substitute it with a verified secure instance. These modifications may occur in real-time during workflow execution to maintain compliance with the execution constraints while ensuring that the high-level computational goal is still achieved.

In some examples, the one more processing circuitries 130, when executing the introductions stored on the non-transitory computer-readable medium may further comprise dynamically selecting instances of the one or more computational components based on the execution constraints. The method may further comprise replacing non-compliant computational component instances dynamically to ensuring compliance with the execution constraints. For example, by dynamically selecting instances of the one or more computational components based on the execution constraints, during the execution of the workflow, specific implementations of computational components are chosen that best satisfy the defined execution constraints, such as performance, security, or resource usage requirements. For example, rather than statically assigning component instances during workflow generation, the system may defer the selection to runtime, evaluating available options within the TE and selecting those that optimize compliance with the execution constraints. For example, to ensure ongoing compliance, the system may dynamically replace a chosen computational component instance during execution if it becomes non-compliant, such as if its performance degrades, if it exceeds permitted resource consumption, or if it no longer satisfies security policies. In such cases, it may seamlessly be switched to an alternative, compliant instance of the computational component, ensuring the workflow continues operating without violating the defined constraints.

For example, when the computational components are service classes, the system may dynamically select a specific service class instance from the available instances within the TE based on the execution constraints. If the execution workflow requires an action such as “payment processing”, and multiple service class instances exist for that action (such as Payment service A, or Payment Service B), the instance that best meets the current constraints may be selected, such as the fastest response time or the highest security rating. During execution, if the selected “Payment Service A” begins to violate an execution constraint, such as exceeding the maximum allowed response time or failing to meet required security levels, the system may dynamically replace it with the “Payment Service B” instance, which is evaluated as compliant with the defined constraints at that moment. This dynamic selection and replacement allow the workflow to adapt in real time to maintain constraint compliance without interrupting the achievement of the computational goal.

The above-described technique may allow the secure and trustworthy execution of an execution workflow that is dynamically assembled based on a user-defined intent specifying a high-level computational goal, by ensuring that the execution workflow is carried out within the isolated execution environment deployed inside the TEE, while continuously monitoring compliance with execution constraints. This may enable to automatically select and replace instances of computational components, such as service class instances, during runtime in response to detected constraint violations, ensuring the workflow remains compliant without manual intervention. By providing such dynamic and policy-driven control over the execution of workflows in potentially untrusted target environments, the technique may allow users to rely on the system to correctly and securely fulfill their computational goals, while generating trusted evidence of execution, such as an execution certificate (see below).

The above-described technique may further allow a shift from traditional static trusted execution models, which may focus on attesting predefined code before execution, to a dynamic, behavior-driven approach that ensures adherence to the user-defined intent throughout the runtime of the execution workflow. Instead of only verifying the integrity of fixed code, the above technique may enable continuous assurance that the actions performed within the execution workflow-including dynamically selected instances of computational components, such as service class instances, or dynamically generated code within the isolated execution environment—remain compliant with the high-level computational goal and the execution constraints. By enabling the monitoring and enforcement of the behavior of the execution workflow as it evolves during runtime, including modifications to the execution path and the dynamic replacement of computational components, the above technique may ensure that the fulfillment of the computational goal remains trustworthy and policy-compliant, even as the specific implementation of the workflow changes during execution.

### Input/Output

In some examples, the one more processing circuitries 130, when executing the introductions stored on the non-transitory computer-readable medium may further comprise monitoring the communication of input and/or output data between the isolated execution environment and external entities. For example, the external entities may be any systems, services, or users outside the isolated execution environment that provide input data to or receive output data from the execution workflow. These external entities may comprise the user initiating the workflow execution by supplying input data, third-party services that are invoked during execution, or endpoints where final results are delivered. The monitoring of communication with the external entities may ensure that only authorized data enters or leaves the isolated execution environment, protecting against injection of malicious inputs, enforcing compliance with confidentiality requirements, and preventing unintended data disclosure. This monitoring may involve validating the structure, type, and content of incoming data against predefined rules or schemas and verifying that output data aligns with privacy or integrity constraints before being sent to its destination.

For example, when a user submits personal information as part of the input data to the execution workflow, the monitoring may check whether the data format complies with expected standards and whether sensitive fields contain valid values, rejecting inputs that are malformed or potentially harmful. Similarly, when the workflow completes and prepares to send output data, such as payment confirmation details, the monitoring may verify that only the necessary information is released, ensuring no internal state data or sensitive execution details are unintentionally included.

In some examples, the one more processing circuitries 130, when executing the introductions stored on the non-transitory computer-readable medium may further comprise receiving input data which may be utilized during the execution of the execution workflow. For example, receiving input data which may be utilized during the execution of the execution workflow may comprise accepting, prior to or during the execution of the workflow, external data provided by a user, an external system, or another process, where this data may be necessary to perform the computational goal defined by the user-defined intent. The input data may include any relevant parameters, resources, or content required by the computational components of the execution workflow, such as user credentials, configuration settings, or task-specific information. In this context, the input data may be transmitted from external entities into the isolated execution environment through a controlled interface that applies monitoring and validation to ensure the input data is safe, correctly formatted, and compliant with applicable execution constraints before it is made available to the workflow.

For example, if the execution workflow is designed to book a flight from Munich to Warsaw, the input data may include passenger details, like passport ID, travel dates, and payment information, all of which are provided by the user or another system. Before this data is processed within the execution workflow, the system may inspect the input to confirm that the travel dates are valid, the payment information meets security standards, and the overall input does not contain unexpected or harmful content. By receiving and validating input data in this controlled manner, the system may ensure that only compliant and trustworthy data is used during the execution of the workflow, reducing the risk of execution failures, security breaches, or violations of the computational goal.

In some examples, the one more processing circuitries 130, when executing the introductions stored on the non-transitory computer-readable medium may further comprise communicating with a service class instance outside the isolated execution environment through a trusted proxy. The trusted proxy may be configured to enforce compliance with the execution constraints. For example, the trusted proxy may be a dedicated control component within TEE or the TE responsible for managing and supervising all communication between the isolated execution environment and external entities, such as external service class instances. The trusted proxy may act as a secure intermediary that intercepts, inspects, and regulates outgoing and incoming requests to ensure that only authorized, policy-compliant service class instances are invoked during the execution of the workflow. The trusted proxy may enforce compliance with execution constraints by verifying that external service class instances meet predefined security standards, operate within specified performance limits, or provide necessary attestations, such as proof of execution within a trusted execution environment. Additionally, the trusted proxy may block, modify, or reroute communications that would otherwise violate execution constraints, thereby maintaining the integrity and trustworthiness of the execution workflow.

For example, during the execution of the workflow for booking a flight from Munich to Warsaw, the workflow may require the use of an external payment processing service. Before allowing the execution workflow to send payment data to a selected payment service class instance, the trusted proxy may check whether the selected instance is running within an approved trusted execution environment, whether it meets the required latency defined in the execution constraints, and whether the service has been properly attested. If the payment service instance fails any of these checks-for instance, if it does not provide the necessary security attestations or responds too slowly-the trusted proxy may block the request and trigger a replacement of the service instance with a compliant alternative, ensuring that the execution workflow continues operating according to the defined execution constraints.

### Execution Certificate

In some examples, the one more processing circuitries 130, when executing the introductions stored on the non-transitory computer-readable medium may further comprise generating an execution certificate. For example, the execution certificate may be a verifiable, tamper-resistant digitally signed data structure generated within the TEE that records and attests to key aspects of the execution of the execution workflow, providing trustworthy evidence that the workflow was executed according to the user-defined intent and within the defined execution constraints. The execution certificate may be created automatically during or after the completion of the execution workflow by specialized components of the system responsible for monitoring the execution, collecting telemetry and compliance data, and securely signing the certificate to ensure its authenticity and integrity. Once generated, the execution certificate may be provided to the user or an external relying party as part of the workflow output, for example together with the result data, and may be used for post-execution analysis, billing in pay-per-use models, service validation, or regulatory audits. In some example, the execution certificate may be used for refunds in the subscription model, for example if a payment was done up front and then refund is demanded in case a service was not provided or only partially provided. The execution certificate may provide assurance that the dynamically assembled and executed workflow, which may involve third-party service class instances and runtime service replacements, behaved as expected, complied with policies, and executed securely within the trusted execution environment.

The execution certificate may comprise at least one of telemetry data of the execution of the execution workflow, compliance verification data based on the monitoring of the execution according to the execution constraints, integrity verification data of the execution within the trusted execution environment and communication data of the isolated execution environment during the execution of the execution workflow. For example, the telemetry data of the execution workflow may include detailed runtime records, such as timestamps, the sequence of executed actions, resource consumption, and any anomalies or failures encountered during execution, enabling an analysis of how the workflow behaved in practice. The compliance verification data may provide confirmation that the execution adhered to the execution constraints, including performance metrics (such as response times), security policies, and other service-level objectives, with logged evidence of whether constraints were met or violated at each step of the workflow. The integrity verification data may contain attestations that the isolated execution environment was properly executed within the TEE (such as Intel® SGX or Intel® TDX), and that the protections of the TEE were maintained throughout execution, ensuring that the workflow was not tampered with, and that sensitive data remained protected. The communication data may document all input and output exchanges between the isolated execution environment and external entities, including details of service class instances called during execution, the data transmitted, and whether these communications complied with the applicable policies and execution constraints. In combination, these elements of the execution certificate may provide the user or external auditors with a complete and trustworthy record of what was executed, how it was executed, and whether the execution fulfilled its obligations.

In some examples, the one more processing circuitries 130, when executing the introductions stored on the non-transitory computer-readable medium may further comprise outputting a result of the execution workflow and the execution certificate from the isolated execution environment after the execution. For example, outputting a result of the execution of the execution workflow and the execution certificate from the isolated execution environment after the execution upon completion of the execution workflow comprises providing the final outcome produced by the workflow—such as processed data, computation results, or service confirmations—together with the corresponding execution certificate, allowing the recipient to not only use the result but also verify that the workflow was executed securely and in compliance with the defined execution constraints. This output may be monitored when it is transmitted from the isolated execution environment to the user or an external system, ensuring that both the result and the execution certificate are protected during transfer and reflect the integrity of the execution. For example, when executing a workflow to book a flight from Munich to Warsaw, the result may be a flight reservation confirmation along with payment status, while the execution certificate provides cryptographically signed evidence that the workflow followed the specified policies, used authorized services, met quality-of-service requirements, and was executed within a trusted execution environment, giving the user confidence in both the validity of the reservation and the trustworthiness of the entire process.

In some examples, the one more processing circuitries 130, when executing the introductions stored on the non-transitory computer-readable medium may further comprise performing a payment based on the execution certificate. For example, after completion of the execution workflow, the execution certificate may be used as a trustworthy basis to calculate and authorize financial transactions related to the use of services involved in the workflow. The execution certificate may provide a detailed, verifiable record of the services consumed, the resources utilized, and the execution constrains achieved during execution, enabling accurate billing in usage-based or pay-per-use models. This ensures that payment is only made for services that were actually executed according to the specified execution constraints, while also providing evidence in case of disputes or audits. The execution certificate may capture which service class instances were used, their runtime durations, and whether any execution constraint violations occurred, making it suitable as a billing reference shared with service providers.

For example, if the execution workflow involves booking a flight from Munich to Warsaw and uses multiple third-party services, such as a payment processor, a flight booking API, and a customer notification service, the execution certificate may list the use of each service, their execution times, and confirm whether they met agreed execution constraints. Based on this certificate, the system may automatically calculate the total costs of the execution and trigger payments to the respective service providers, such as paying the airline booking service for the reservation and compensating the infrastructure provider for compute time, ensuring transparent and verifiable billing.

In some examples, the one more processing circuitries 130, when executing the introductions stored on the non-transitory computer-readable medium may further comprise performing a penalty based on the execution certificate. For example, if the execution certificate indicates that certain execution constraints were violated—such as failing to meet guaranteed parameters like maximum response times or availability—then automatically a penalty may be applied against the responsible service provider or environment. This may involve calculating a partial refund, credit, or other compensation for the user, based on the documented violations recorded within the execution certificate. In cases such as subscription-based service models, where the user has prepaid for guaranteed service levels, the execution certificate serves as verifiable evidence of non-compliance, enabling the system to enforce financial penalties without the need for manual dispute resolution.

For example, if the execution workflow is booked under a service agreement that guarantees all external services respond within 200 milliseconds, but the execution certificate shows that a payment processing service exceeded this threshold multiple times during the workflow, a proportional refund may be automatically applied to the user's account or deduct the appropriate penalty from the service provider's compensation. This ensures that service-level agreements are enforced transparently and fairly, with the execution certificate serving as the trusted basis for triggering and calculating such penalties.

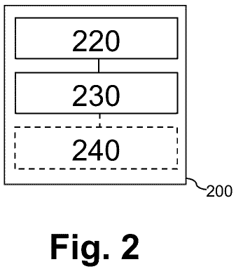

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-5).

FIG. 2 illustrates a block diagram of an example of an apparatus 200 or device 200. The apparatus 200 comprises circuitry that is configured to provide the functionality of the apparatus 200. For example, the apparatus 200 of FIG. 2 comprises interface circuitry 220, processing circuitry 230 and (optional) storage circuitry 240. For example, the processing circuitry 230 may be coupled with the interface circuitry 220 and optionally with the storage circuitry 240.

For example, the processing circuitry 230 may be configured to provide the functionality of the apparatus 200, in conjunction with the interface circuitry 220. For example, the interface circuitry 220 is configured to exchange information, e.g., with other components inside or outside the apparatus 200 and the storage circuitry 240. Likewise, the device 200 may comprise means that is/are configured to provide the functionality of the device 200.

The components of the device 200 are defined as component means, which may correspond to, or implemented by, the respective structural components of the apparatus 200. For example, the device 200 of FIG. 2 comprises means for processing 230, which may correspond to or be implemented by the processing circuitry 230, means for communicating 220, which may correspond to or be implemented by the interface circuitry 220, and (optional) means for storing information 240, which may correspond to or be implemented by the storage circuitry 240. In the following, the functionality of the device 200 is illustrated with respect to the apparatus 200. Features described in connection with the apparatus 200 may thus likewise be applied to the corresponding device 200.

In general, the functionality of the processing circuitry 230 or means for processing 230 may be implemented by the processing circuitry 230 or means for processing 230 executing machine-readable instructions. Accordingly, any feature ascribed to the processing circuitry 230 or means for processing 230 may be defined by one or more instructions of a plurality of machine-readable instructions. The apparatus 200 or device 200 may comprise the machine-readable instructions, e.g., within the storage circuitry 240 or means for storing information 240.

The interface circuitry 220 or means for communicating 220 may correspond to one or more inputs and/or outputs for receiving and/or transmitting information, which may be in digital (bit) values according to a specified code, within a module, between modules or between modules of different entities. For example, the interface circuitry 220 or means for communicating 220 may comprise circuitry configured to receive and/or transmit information.

For example, the processing circuitry 230 or means for processing 230 may be implemented using one or more processing units, one or more processing devices, any means for processing, such as a processor, a computer or a programmable hardware component being operable with accordingly adapted software. In other words, the described function of the processing circuitry 230 or means for processing 230 may as well be implemented in software, which is then executed on one or more programmable hardware components. Such hardware components may comprise a general-purpose processor, a Digital Signal Processor (DSP), a micro-controller, etc.

For example, the storage circuitry 240 may comprise one or more components of the non-transitory computer-readable medium 140. For example, the storage circuitry 240 may store instructions that, when executed by the processing circuitry 230, may cause the processing circuitry to perform the method. The storage circuitry 240 or means for storing information 240 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 230 is configured to receive a user-defined intent specifying a high-level computational goal. The processing circuitry 230 is further configured to generate an execution workflow of the computational goal based on the one or more computational components corresponding to the user-defined intent. The processing circuitry 230 is further configured to execute the execution workflow according to obtained execution constraints. The execution workflow is executed within an isolated execution environment. The isolated execution environment being deployed inside a trusted execution environment. The processing circuitry 230 is further configured to monitor the execution of the execution workflow within the isolated execution environment ensuring compliance with the execution constraints.

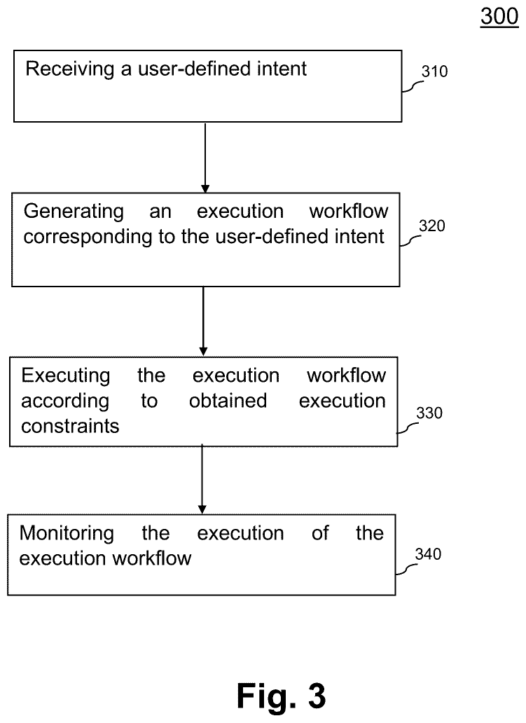

Further details and aspects are mentioned in connection with the examples described above or below. The example shown in FIG. 2 may include one or more optional additional features corresponding to one or more aspects mentioned in connection with the proposed concept or one or more examples described above (e.g., FIG. 1) or below (e.g., FIGS. 3-5).

FIG. 3 illustrates a flowchart of an example of a method 300. The method 300 may be performed by an apparatus as described herein, such as apparatus 100 or 200. The method 300 may performed by the apparatus 100 (for example the one or more processing circuitries 130), when executing the instructions stored on the non-transitory computer-readable medium described herein, such as the non-transitory computer-readable 140. The method 300 comprises receiving 310 a user-defined intent specifying a high-level computational goal. The method 300 comprises further generating 320 an execution workflow of the computational goal based on the one or more computational components corresponding to the user-defined intent. The method 300 comprises further executing 330 the execution workflow according to obtained execution constraints. The execution workflow is executed within an isolated execution environment, the isolated execution environment being deployed inside a trusted execution environment. The method 300 comprises further monitoring 340 the execution of the execution workflow within the isolated execution environment ensuring compliance with the execution constraints

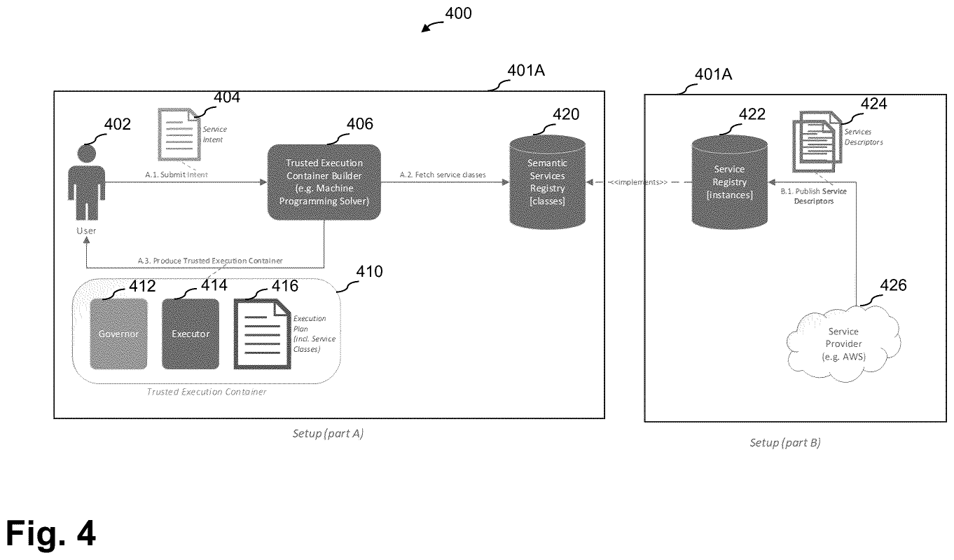

More details and aspects of the method 300 are explained in connection with the proposed technique or one or more examples described above, or below. The method 300 may comprise one or more additional optional features corresponding to one or more aspects of the proposed technique, or one or more examples described above (e.g., FIGS. 1-2) or below (e.g., FIGS. 4 to 5).

### Further Examples

The examples shown in FIGS. 4 and 5 below reflect two stages of the intent-based programing technique as described above. First, in setup stage 400 (see FIG. 4) a solver component is responsible for translating user-defined intent into an executable workflow encapsulated from example, in trusted execution container. In a runtime stage 500, the trusted execution container gets executed in a target environment. For example, the building blocks used by the solver may be web services offered by a 3rd party service provider (like MSFT Azure or AWS). In other examples, they may be software libraries/executables/scripts executing directly inside the container.

For example, the components and units depicted in the FIGS. 4 and 5 may be understood as illustrative purposes and may represent logical, virtual, or physical entities. In some examples, the components and units may be implemented in software, hardware, or a combination thereof and may be distributed across multiple systems, instances, or environments as appropriate for the specific implementation.

FIG. 4 illustrates an example of a setup stage 400 of a programming flow for user-defined intent programming. The setup stage 400 shows a flow for generating a trusted execution container 410 configured to securely execute a dynamically assembled execution workflow corresponding to a user-defined intent 404. The setup stage 400 is divided into two independent parts, Part 401A and Part 401B.

In Part 401A, a user 402 provides a user-defined intent 404 specifying a high-level computational goal to be executed. The user-defined intent 404 may be, for example, expressed using a general-purpose intent-driven programming language, such as FAST (see Yang, Yao-Hsiang, et al. “Language Support for Adaptation: Intent-Driven Programming in FAST.” arXiv preprint arXiv:1907.08695 (2019)). The user-defined intent 404 is transmitted to a trusted execution container Builder 406, which analyzes the user-defined intent 404 to extract one or more actions of the computational goal and to identify corresponding computational components that may be required to fulfill the computational goal. To this end, the trusted execution container Builder 406 queries a Semantic Service Registry 420, which stores descriptions of available computational components, such as service classes, including semantic information relating to their functionalities, input and output data types, and other relevant properties. Based on this analysis, the trusted execution container Builder 406 generates a trusted execution container 410 (also referred to as isolated execution environment). The trusted execution container 410 includes an execution workflow 416 (also referred to as an execution plan), an Executor 412, and Governor components 414. The execution workflow 416 may define the business logic necessary to realize the computational goal by orchestrating the identified computational components. The execution workflow 416 may, for example, be generated in the form of an executable workflow as described in the paper Khalfallah, Malik, et al. “Generating Executable Workflows from Solution Plans.” The Executor 412 may execute the execution workflow 416 during runtime, and the Governor components 414 may monitor the execution and ensure compliance with execution constraints, as described in further detail with respect to FIG. 5. The trusted execution container 410 is configured to operate within a Trusted Execution Environment and may provide confidentiality, integrity, and remote attestation capabilities. The trusted execution container 410 is provided back to the user 402 for deployment in a target environment.

In Part 401B, a Service Provider 424 may publish descriptions of available services into a Service Registry 422. These service descriptions may be defined using a machine-readable knowledge representation language, such as Web Ontology Language (OWL) (see Semantic Web Standards Definition https://www.w3.org/2001/sw/#owl), allowing the services to be semantically described using ontologies and organized in subsumption hierarchies based on their functionalities, input and output data types, and other relevant attributes. The service descriptions from the Service Registry 422 may be provided to the Semantic Service Registry 420 to support the identification and selection of computational components during the generation of the execution workflow 416. The services described in the Service Registry 422 may correspond to services available in a target environment 426, such as a cloud computing platform. The setup stage 400 thus enables the generation of the trusted execution container 410, which encapsulates all elements necessary to securely execute the computational goal corresponding to the user-defined intent 404 while ensuring formal assurance and compliance with execution constraints during runtime.

FIG. 5 illustrates an example of a runtime stage 500 of a programming flow for user-defined intent programming. The runtime stage 500 shows how the generated trusted execution container securely executes the dynamically assembled execution workflow according to the user-defined intent while ensuring formal assurance, monitoring, and compliance with execution constraints. The trusted execution container 410 comprises the execution workflow 416, the executor 412 and the governor components 414.

The runtime stage 500 comprises the following steps: In step 1, the user 402 initiates the execution of the trusted execution container 410 within the TEE 530 of a target environment (TE). The user 402 provides input data and quality of QoS requirements 504 (execution constraints) to the trusted execution container 410. The input data and QoS requirements 504 are received and processed by the governed execution facade 510 (for example part of the governor 412). The governed execution facade 510 is configured to validate and filter the input data and QoS requirements 504 to prevent potentially harmful inputs or data that may compromise the integrity or confidentiality of the execution.

In step 2, the governed execution facade 510 provisions a QoS monitor 512 (for example part of the governor 412) with the QoS requirements 504 specified by the user 402. These QoS requirements define the operational boundaries and objectives to be monitored and enforced during the execution of the execution workflow.

In step 3, the governed execution facade 510 provides the executor 414 with the validated input data, along with the QoS requirements 504 if applicable. The executor 414 is configured to perform the execution of the execution workflow 416, which is embedded within the trusted execution container 410, and defines the business logic necessary to achieve the computational goal specified in the user-defined intent.

In step 4, the executor 414 reads the execution workflow 416 embedded within the trusted execution container 410, which orchestrates the sequence of computational components required to fulfill the computational goal. The execution workflow 416 may describe the dependencies and interactions between the computational components and their respective input and output data formats.

In step 5, the executor 414 queries a service registry 518 via a trusted service proxy 516 (for example part of the governor 412) to obtain available services required to execute the execution workflow 416. The service registry 518 contains descriptions of service class instances deployed in the target environment 520 (such as cloud services), which provide the functionalities needed for the execution workflow.

In step 6, the executor 414 executes the execution workflow 416 by invoking the identified service class instances through the trusted service proxy 516. The trusted service proxy 516 acts as a control layer that enforces compliance of external service interactions with the execution constraints. The trusted service proxy 516 may perform checks on the compliance of the selected service class instances, such as verifying if they are part of a confidential computing offering, and may block non-compliant traffic.

In step 7, upon successful completion of the execution workflow, the executor 414 returns the execution results to the governed execution facade 510. The governed execution facade 510 may further validate and filter the output data to prevent unintended data exposure before returning it to the user 402.

In step 8, the execution certificate certification authority 514 (for example part of the governor 412) retrieves telemetry data from the QoS monitor 512, which has monitored the activities of the executor 414 and the trusted service proxy 516 throughout the execution. This telemetry data may include information such as execution events, duration, service calls, exceptions, and adherence to the QoS requirements.

In step 9, the execution certificate authority 514 generates an execution certificate 522 based on the telemetry data and the QoS requirements. The execution certificate 522 provides a trusted record of the execution, documenting which services were used, whether the execution constraints were met, and capturing an auditable log of the execution process. The execution certificate 522 is returned to the governed execution facade 510.

In step 10, the governed execution facade 510 returns the execution results, along with the execution certificate 522, to the user 402 as the final output of the execution workflow.

In step 11, the user 402 may utilize the execution certificate 522 for various post-execution purposes, such as payment calculations with a billing system 526 in a pay-per-use model or requesting penalties or refunds from the service provider if QoS violations are detected.

Further details and aspects are mentioned in connection with the examples described above. The example shown in FIGS. 4 and 5 may include one or more optional additional features corresponding to one or more aspects mentioned in connection with the proposed concept or one or more examples described above (e.g., FIGS. 1-3).

In the following, some examples of the proposed concept are presented:

An example (e.g., example 1) relates to a non-transitory computer-readable medium storing instructions that, when executed by one or more processing circuitries, causing the one or more processing circuitries to perform a method comprising receiving a user-defined intent specifying a high-level computational goal, generating an execution workflow of the computational goal based on one or more computational components corresponding to the user-defined intent, executing the execution workflow according to obtained execution constraints wherein the execution workflow is executed within an isolated execution environment, the isolated execution environment being deployed inside a trusted execution environment, monitoring the execution of the execution workflow within the isolated execution environment ensuring compliance with the execution constraints.

Another example (e.g., example 2) relates to a previous example (e.g., example 1) or to any other example, further comprising that the method further comprises modifying the execution of the execution workflow upon detecting a violation of an execution constraint, in accordance with an execution policy.

Another example (e.g., example 3) relates to a previous example (e.g., one of the examples 1 to 2) or to any other example, further comprising that the method further comprises dynamically selecting instances of the one or more computational components based on the execution constraints, replacing non-compliant computational component instances dynamically to ensuring compliance with the execution constraints.

Another example (e.g., example 4) relates to a previous example (e.g., one of the examples 1 to 3) or to any other example, further comprising that the computational components comprise at least one of a service class, a script, dynamically compiled code, or an execution module.

Another example (e.g., example 5) relates to a previous example (e.g., one of the examples 1 to 4) or to any other example, further comprising that generating the execution workflow of the computational goal is further based on the obtained execution constraints.

Another example (e.g., example 6) relates to a previous example (e.g., one of the examples 1 to 5) or to any other example, further comprising that the method further comprises monitoring the communication of input and/or output data between the isolated execution environment and external entities.

Another example (e.g., example 7) relates to a previous example (e.g., one of the examples 1 to 6) or to any other example, further comprising that the method further comprises communicating with a service class instance outside the isolated execution environment through a trusted proxy, the trusted proxy being configured to enforce compliance with the execution constraints.

Another example (e.g., example 8) relates to a previous example (e.g., one of the examples 1 to 7) or to any other example, further comprising that the method further comprises receiving input data which is utilized during the execution of the execution workflow.

Another example (e.g., example 9) relates to a previous example (e.g., one of the examples 1 to 8) or to any other example, further comprising that the method further comprises generating an execution certificate, the execution certificate comprising at least one of telemetry data of the execution of the execution workflow, compliance verification data based on the monitoring of the execution according to the execution constraints, integrity verification data of the execution within the trusted execution environment or communication data of the isolated execution environment during the execution of the execution workflow.

Another example (e.g., example 10) relates to a previous example (e.g., example 9) or to any other example, further comprising that the method further comprises outputting a result of the execution of the execution workflow and the execution certificate from the isolated execution environment after the execution.

Another example (e.g., example 11) relates to a previous example (e.g., one of the examples 9 to 10) or to any other example, further comprising that the method further comprises performing a payment based on the execution certificate.

Another example (e.g., example 12) relates to a previous example (e.g., one of the examples 9 to 11) or to any other example, further comprising that the method further comprises performing a penalty based on the execution certificate.

Another example (e.g., example 13) relates to a previous example (e.g., one of the examples 1 to 12) or to any other example, further comprising that the trusted execution environment is deployed in a target environment, the target environment providing one or more instances of the one or more computational components.

Another example (e.g., example 14) relates to a previous example (e.g., example 13) or to any other example, further comprising that the target environment is at least one of a cloud environment, an on-premises server infrastructure, or an edge computing environment

Another example (e.g., example 15) relates to a previous example (e.g., one of the examples 1 to 14) or to any other example, further comprising that the trusted execution environment is at least one of an Intel® software guard extensions, SGX or an Intel® trust domain extensions, TDX.

Another example (e.g., example 16) relates to a previous example (e.g., one of the examples 1 to 15) or to any other example, further comprising that the isolated execution environment is at least one of a virtual machine, a container or a software application.

Another example (e.g., example 17) relates to a previous example (e.g., one of the examples 1 to 16) or to any other example, further comprising that the received user-defined intent comprises one or more actions of the computational goal.

Another example (e.g., example 18) relates to a previous example (e.g., one of the examples 1 to 17) or to any other example, further comprising that the method further comprises parsing the received intent to extract one or more actions of the computational goal.

Another example (e.g., example 19) relates to a previous example (e.g., one of the examples 1 to 18) or to any other example, further comprising that the method further comprises querying a service registry to identify one or more service classes matching the extracted actions of the computational goal.

An example (e.g., example 20) relates to an apparatus comprising interface circuitry, machine-readable instructions and processing circuitry to execute the machine-readable instructions to receive a user-defined intent specifying a high-level computational goal, generate an execution workflow of the computational goal based on the one or more computational components corresponding to the user-defined intent, execute the execution workflow according to obtained execution constraints wherein the execution workflow is executed within an isolated execution environment, the isolated execution environment being deployed inside a trusted execution environment, monitor the execution of the execution workflow within the isolated execution environment ensuring compliance with the execution constraints.

Another example (e.g., example 21) relates to a previous example (e.g., example 20) or to any other example, further comprising that the processing circuitry is further to execute the machine-readable instructions to modify the execution of the execution workflow upon detecting a violation of an execution constraint, in accordance with an execution policy.

Another example (e.g., example 22) relates to a previous example (e.g., one of the examples 20 to 21) or to any other example, further comprising that the processing circuitry is further to execute the machine-readable instructions to dynamically select instances of the one or more computational components based on the execution constraints, replace non-compliant computational component instances dynamically to ensure compliance with the execution constraints.

Another example (e.g., example 23) relates to a previous example (e.g., one of the examples 20 to 22) or to any other example, further comprising that the computational components comprise at least one of a service class, a script, dynamically compiled code, or an execution module.

Another example (e.g., example 24) relates to a previous example (e.g., one of the examples 20 to 23) or to any other example, further comprising that the processing circuitry is further to execute the machine-readable instructions to generate the execution workflow of the computational goal based on the obtained execution constraints.

Another example (e.g., example 25) relates to a previous example (e.g., one of the examples 20 to 24) or to any other example, further comprising that the processing circuitry is further to execute the machine-readable instructions to monitor the communication of input and/or output data between the isolated execution environment and external entities.

Another example (e.g., example 26) relates to a previous example (e.g., one of the examples 20 to 25) or to any other example, further comprising that the processing circuitry is further to execute the machine-readable instructions to communicate with a service class instance outside the isolated execution environment through a trusted proxy, the trusted proxy being configured to enforce compliance with the execution constraints.

Another example (e.g., example 27) relates to a previous example (e.g., one of the examples 20 to 26) or to any other example, further comprising that the processing circuitry is further to execute the machine-readable instructions to receive input data which is utilized during the execution of the execution workflow.

Another example (e.g., example 28) relates to a previous example (e.g., one of the examples 20 to 27) or to any other example, further comprising that the processing circuitry is further to execute the machine-readable instructions to generate an execution certificate, the execution certificate comprising at least one of telemetry data of the execution of the execution workflow, compliance verification data based on the monitoring of the execution according to the execution constraints, integrity verification data of the execution within the trusted execution environment, or communication data of the isolated execution environment during the execution of the execution workflow.

Another example (e.g., example 29) relates to a previous example (e.g., example 28) or to any other example, further comprising that the processing circuitry is further to execute the machine-readable instructions to output a result of the execution of the execution workflow and the execution certificate from the isolated execution environment after the execution.

Another example (e.g., example 30) relates to a previous example (e.g., one of the examples 28 to 29) or to any other example, further comprising that the processing circuitry is further to execute the machine-readable instructions to perform a payment based on the execution certificate.

Another example (e.g., example 31) relates to a previous example (e.g., one of the examples 28 to 30) or to any other example, further comprising that the processing circuitry is further to execute the machine-readable instructions to perform a penalty based on the execution certificate.

Another example (e.g., example 32) relates to a previous example (e.g., one of the examples 20 to 31) or to any other example, further comprising that the trusted execution environment is deployed in a target environment, the target environment providing one or more instances of the one or more computational components.

Another example (e.g., example 33) relates to a previous example (e.g., example 32) or to any other example, further comprising that the target environment is at least one of a cloud environment, an on-premises server infrastructure, or an edge computing environment.

Another example (e.g., example 34) relates to a previous example (e.g., one of the examples 20 to 33) or to any other example, further comprising that the trusted execution environment is at least one of an Intel® software guard extensions, SGX, or an Intel® trust domain extensions, TDX.

Another example (e.g., example 35) relates to a previous example (e.g., one of the examples 20 to 34) or to any other example, further comprising that the isolated execution environment is at least one of a virtual machine, a container, or a software application.

Another example (e.g., example 36) relates to a previous example (e.g., one of the examples 20 to 35) or to any other example, further comprising that the received user-defined intent comprises one or more actions of the computational goal.

Another example (e.g., example 37) relates to a previous example (e.g., one of the examples 20 to 36) or to any other example, further comprising that the processing circuitry is further to execute the machine-readable instructions to parse the received intent to extract one or more actions of the computational goal.

Another example (e.g., example 38) relates to a previous example (e.g., one of the examples 20 to 37) or to any other example, further comprising that the processing circuitry is further to execute the machine-readable instructions to query a service registry to identify one or more service classes matching the extracted actions of the computational goal.

An example (e.g., example 39) relates to a method comprising receiving a user-defined intent specifying a high-level computational goal, generating an execution workflow of the computational goal based on the one or more computational components corresponding to the user-defined intent, executing the execution workflow according to obtained execution constraints wherein the execution workflow is executed within an isolated execution environment, the isolated execution environment being deployed inside a trusted execution environment, monitoring the execution of the execution workflow within the isolated execution environment ensuring compliance with the execution constraints.

Another example (e.g., example 40) relates to a previous example (e.g., example 39) or to any other example, further comprising modifying the execution of the execution workflow upon detecting a violation of an execution constraint, in accordance with an execution policy.

Another example (e.g., example 41) relates to a previous example (e.g., one of the examples 39 to 40) or to any other example, further comprising dynamically selecting instances of the one or more computational components based on the execution constraints, replacing non-compliant computational component instances dynamically to ensure compliance with the execution constraints.

Another example (e.g., example 42) relates to a previous example (e.g., one of the examples 39 to 41) or to any other example, further comprising that the computational components comprise at least one of a service class, a script, dynamically compiled code, or an execution module.

Another example (e.g., example 43) relates to a previous example (e.g., one of the examples 39 to 42) or to any other example, further comprising that generating the execution workflow of the computational goal is further based on the obtained execution constraints.

Another example (e.g., example 44) relates to a previous example (e.g., one of the examples 39 to 43) or to any other example, further comprising monitoring the communication of input and/or output data between the isolated execution environment and external entities.

Another example (e.g., example 45) relates to a previous example (e.g., one of the examples 39 to 44) or to any other example, further comprising communicating with a service class instance outside the isolated execution environment through a trusted proxy, the trusted proxy being configured to enforce compliance with the execution constraints.

Another example (e.g., example 46) relates to a previous example (e.g., one of the examples 39 to 45) or to any other example, further comprising receiving input data which is utilized during the execution of the execution workflow.

Another example (e.g., example 47) relates to a previous example (e.g., one of the examples 39 to 46) or to any other example, further comprising generating an execution certificate, the execution certificate comprising at least one of telemetry data of the execution of the execution workflow, compliance verification data based on the monitoring of the execution according to the execution constraints, integrity verification data of the execution within the trusted execution environment, or communication data of the isolated execution environment during the execution of the execution workflow.

Another example (e.g., example 48) relates to a previous example (e.g., example 47) or to any other example, further comprising outputting a result of the execution of the execution workflow and the execution certificate from the isolated execution environment after the execution.

Another example (e.g., example 49) relates to a previous example (e.g., one of the examples 47 to 48) or to any other example, further comprising performing a payment based on the execution certificate.

Another example (e.g., example 50) relates to a previous example (e.g., one of the examples 47 to 49) or to any other example, further comprising performing a penalty based on the execution certificate.

Another example (e.g., example 51) relates to a previous example (e.g., one of the examples 39 to 50) or to any other example, further comprising that the trusted execution environment is deployed in a target environment, the target environment providing one or more instances of the one or more computational components.

Another example (e.g., example 52) relates to a previous example (e.g., example 51) or to any other example, further comprising that the target environment is at least one of a cloud environment, an on-premises server infrastructure, or an edge computing environment.

Another example (e.g., example 53) relates to a previous example (e.g., one of the examples 39 to 52) or to any other example, further comprising that the trusted execution environment is at least one of an Intel® software guard extensions, SGX, or an Intel® trust domain extensions, TDX.

Another example (e.g., example 54) relates to a previous example (e.g., one of the examples 39 to 53) or to any other example, further comprising that the isolated execution environment is at least one of a virtual machine, a container, or a software application.

Another example (e.g., example 55) relates to a previous example (e.g., one of the examples 39 to 54) or to any other example, further comprising that the received user-defined intent comprises one or more actions of the computational goal.

Another example (e.g., example 56) relates to a previous example (e.g., one of the examples 39 to 55) or to any other example, further comprising parsing the received intent to extract one or more actions of the computational goal.

Another example (e.g., example 57) relates to a previous example (e.g., one of the examples 39 to 56) or to any other example, further comprising querying a service registry to identify one or more service classes matching the extracted actions of the computational goal.

An example (e.g., example 58) relates to an apparatus comprising a processor circuitry configured to receive a user-defined intent specifying a high-level computational goal, generate an execution workflow of the computational goal based on one or more computational components corresponding to the user-defined intent, execute the execution workflow according to obtained execution constraints wherein the execution workflow is executed within an isolated execution environment, the isolated execution environment being deployed inside a trusted execution environment, monitor the execution of the execution workflow within the isolated execution environment ensuring compliance with the execution constraints.

An example (e.g., example 59) relates to a device comprising means for processing for receiving a user-defined intent specifying a high-level computational goal, generating an execution workflow of the computational goal based on one or more computational components corresponding to the user-defined intent, executing the execution workflow according to obtained execution constraints wherein the execution workflow is executed within an isolated execution environment, the isolated execution environment being deployed inside a trusted execution environment, monitoring the execution of the execution workflow within the isolated execution environment ensuring compliance with the execution constraints.

Another example (e.g., example 60) relates to a computer program having a program code for performing the method of any one of examples 39 to 57 when the computer program is executed on a computer, a processor, or a programmable hardware component.

Another example (e.g., example 61) relates a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory computer-readable medium storing instructions that, when executed by one or more processing circuitries, causing the one or more processing circuitries to perform a method comprising:
receiving a user-defined intent specifying a high-level computational goal;
generating an execution workflow of the computational goal based on one or more computational components corresponding to the user-defined intent;
executing the execution workflow according to obtained execution constraints
wherein the execution workflow is executed within an isolated execution environment, the isolated execution environment being deployed inside a trusted execution environment;
monitoring the execution of the execution workflow within the isolated execution environment ensuring compliance with the execution constraints.

2. The computer-readable medium of claim 1, wherein the method further comprises modifying the execution of the execution workflow upon detecting a violation of an execution constraint, in accordance with an execution policy.

3. The computer-readable medium claim 1, wherein the method further comprises dynamically selecting instances of the one or more computational components based on the execution constraints;
replacing non-compliant computational component instances dynamically to ensuring compliance with the execution constraints.

4. The computer-readable medium of claim 1, wherein the computational components comprise at least one of a service class, a script, dynamically compiled code, or an execution module.

5. The computer-readable medium of claim 1, wherein generating the execution workflow of the computational goal is further based on the obtained execution constraints.

6. The computer-readable medium of claim 1, wherein the method further comprises monitoring the communication of input and/or output data between the isolated execution environment and external entities.

7. The computer-readable medium of claim 1, wherein the method further comprises communicating with a service class instance outside the isolated execution environment through a trusted proxy, the trusted proxy being configured to enforce compliance with the execution constraints.

8. The computer-readable medium of claim 1, wherein the method further comprises receiving input data which is utilized during the execution of the execution workflow.

9. The computer-readable medium of claim 1, wherein the method further comprises generating an execution certificate, the execution certificate comprising at least one of telemetry data of the execution of the execution workflow, compliance verification data based on the monitoring of the execution according to the execution constraints, integrity verification data of the execution within the trusted execution environment or communication data of the isolated execution environment during the execution of the execution workflow.

10. The computer-readable medium of claim 9, wherein the method further comprises outputting a result of the execution of the execution workflow and the execution certificate from the isolated execution environment after the execution.

11. The computer-readable medium of claim 9, wherein the method further comprises performing a payment based on the execution certificate.

12. The computer-readable medium of claim 9, wherein the method further comprises performing a penalty based on the execution certificate.

13. The computer-readable medium of claim 1, wherein the trusted execution environment is deployed in a target environment, the target environment providing one or more instances of the one or more computational components.

14. The computer-readable medium of claim 13, wherein the target environment is at least one of a cloud environment, an on-premises server infrastructure, or an edge computing environment

15. The computer-readable medium of a claim 1, wherein the trusted execution environment is at least one of an Intel® software guard extensions, SGX or an Intel® trust domain extensions, TDX.

16. The computer-readable medium of claim 1, wherein the isolated execution environment is at least one of a virtual machine, a container or a software application.

17. The computer-readable medium of claim 1, wherein the received user-defined intent comprises one or more actions of the computational goal.

18. The computer-readable medium of claim 1, wherein the method further comprises parsing the received intent to extract one or more actions of the computational goal.

19. An apparatus comprising interface circuitry, machine-readable instructions and processing circuitry to execute the machine-readable instructions to:
receive a user-defined intent specifying a high-level computational goal;
generate an execution workflow of the computational goal based on the one or more computational components corresponding to the user-defined intent;
execute the execution workflow according to obtained execution constraints
wherein the execution workflow is executed within an isolated execution environment, the isolated execution environment being deployed inside a trusted execution environment;
monitor the execution of the execution workflow within the isolated execution environment ensuring compliance with the execution constraints. goal.

20. A method comprising:
receiving a user-defined intent specifying a high-level computational goal;
generating an execution workflow of the computational goal based on the one or more computational components corresponding to the user-defined intent;
executing the execution workflow according to obtained execution constraints
wherein the execution workflow is executed within an isolated execution environment, the isolated execution environment being deployed inside a trusted execution environment;
monitoring the execution of the execution workflow within the isolated execution environment ensuring compliance with the execution constraints.
